(19) United States
(12) Patent Application Publication
(10) Pub. No.: US 2008/0310815 A1
(43) Pub. Date: Dec. 18, 2008

(54) Method and Apparatus For Playing Video

(75) Inventors: Dahua He, Shanghai (CN); Mo Li, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,436

(22) PCT Filed: Nov. 21, 2006
(86) PCT No.: PCT/IB06/54347

§ 371 Date: May 21, 2008

(30) Foreign Application Priority Data
Nov. 23, 2005 (CN) 200510128671.7

(51) Int. Cl. H04N 7/00; G11B 27/19

(52) U.S. Cl. 386/46

(57) ABSTRACT

The present invention relates to the field of video playing. The method of playing video according to the invention comprises: receiving an event; looking up the PlayItems that simulate the event according to this event; and playing the play clips that correspond to said PlayItems.

### FIELD OF THE INVENTION

The present invention relates to the field of video playing, in particular to a method and apparatus for playing video.

### BACKGROUND OF THE INVENTION

With the development of optical disc technology, a user can enter a world of higher quality entertainment by interacting with the contents of an optical disc. The interaction between the user and the contents of an optical disc is manifested in the following way: controlling the sequence and manner of playing contents in accordance with the user's requirement and input information, or the content of an optical disc comprising a movie or the games associated with the content of the movie, the user can interactively play games with movie video at the same time as viewing the movies on optical discs, wherein the optical disc may be a Blu-ray Disc BD and High-Definition Digital Versatile Disc HD-DVD. Said video may be 3D or 2D-video.

Most of the games associated with the content of the movie are presented by the video similar to the movie, and the video similar to the movie is screened by real actors and at real scenes. To those viewers or game players, the video similar to the movie will bring them a sense of true environment.

The existing BD standard defines a mechanism that simply interacts with the video content in a BD HD MOVIE mode (see Part 3, chapter 3 of the description of the system in BD read-only format for details). As shown in FIG. 1, the Blu-ray movie mode has four layers to administrate AV stream files, namely: an Index table, a Movie Object, a PlayList and a Clip. A pair of AV stream files and their attributes form clips. The PlayList is a linear sequence of play time of the clips, whereas the play time is called a PlayItem.

FIG. 2 is a schematic diagram illustrating the structure of a movie object in BD standard. The movie object is an executable navigation command program that allows dynamic scenario description. The movie object is a layer above the PlayList, the navigation command of the movie object can activate the PlayList to be played or the movie object can call another movie object, so that a group of movie objects will administrate the playing of the PlayList according to the user interaction and user preference.

If a scenario has a branch or a junction point, this point has to be located within the border of a PlayList. Connecting the playback of a PlayList to that of another PlayList is realized by a programming method. The use of all the features can realize a simple interaction with the video playback, for example, title selection, and scene switch, etc.

Below is the method adopted for controlling the playing of video and video games:

When the user enters information (hereinafter referred to as events) to control the video playing or video game playing, according to the regulation of optical disc standard, for example, BD, the play system will re-start a PlayList according to said events, then find the corresponding PlayItems in the re-started PlayList via said events so as to play the contents of the clips corresponding to said events.

In the prior art, however, in order to find the PlayItems corresponding to said events so as to realize the playing of the clips adaptable to said events, the play system forst has to restart the PlayList corresponding to the PlayItems, which necessarily takes certain start time, thereby leading to the result that the video or video game is not played smoothly according to the user's requirement (see Part III, Chapter 3.3.1.1 of the description of the system in BD read-only format) and the object of entertaining the user by using video or video games cannot be fully achieved either.

### OBJECT AND SUMMARY OF THE INVENTION

An object of the invention is to provide a method and apparatus for seamlessly playing video under the control of a user.

The video-playing method according to the invention wherein the video playing process is carried out according to the events issued from a user control platform comprises the steps of: receiving an event; looking-up the PlayItems that simulate said events according to said events; and playing the play clips corresponding to said PlayItems.

The video-playing method according to the invention can directly find the PlayItems corresponding to said events without re”-starting the PlayList, thereby accomplishing better seamless playing.

The invention also provides a playing apparatus for implementing said video-playing method of the invention.

Through the description of the invention made with reference to the accompanying drawings and the claims, other objects and achievements of the invention will become obvious, and a complete understanding of the invention will be obtained.

### BRIEF DESCRIPTION OF THE DRAWINGS

The embodiments of the invention will be described in detail with reference to the accompanying drawings, wherein:

FIG. 1 illustrates a structure for managing AV stream files in a BD standard movie mode;

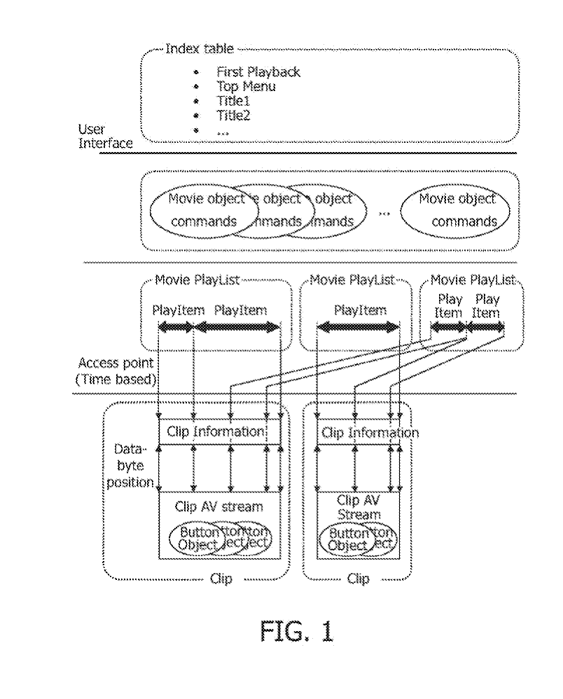

FIG. 2 is a schematic diagram illustrating the structure of a movie object in a BD standard;

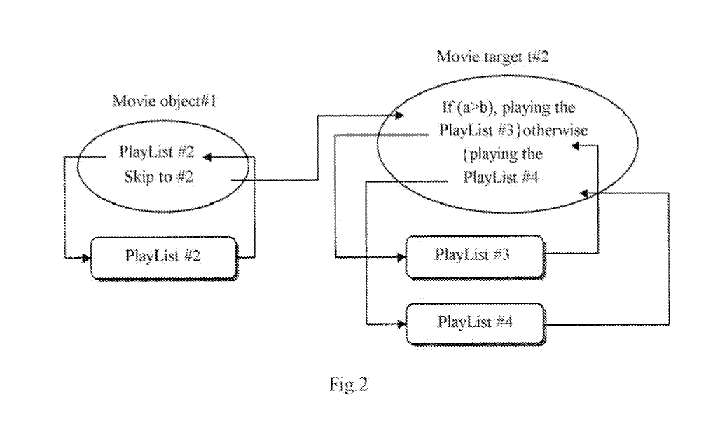

FIG. 3 is a flow chart according to an embodiment of the video-playing method;

FIG. 4 is a flow chart according to an embodiment of the video-playing method of the invention;

FIG. 5 is a schematic diagram of video playing according to the invention;

FIG. 6 is a structural block diagram according to an embodiment of the video-playing apparatus of the invention.

In the drawings, the same reference sign represents the same or similar feature and function.

### DETAILED DESCRIPTION OF THE INVENTION

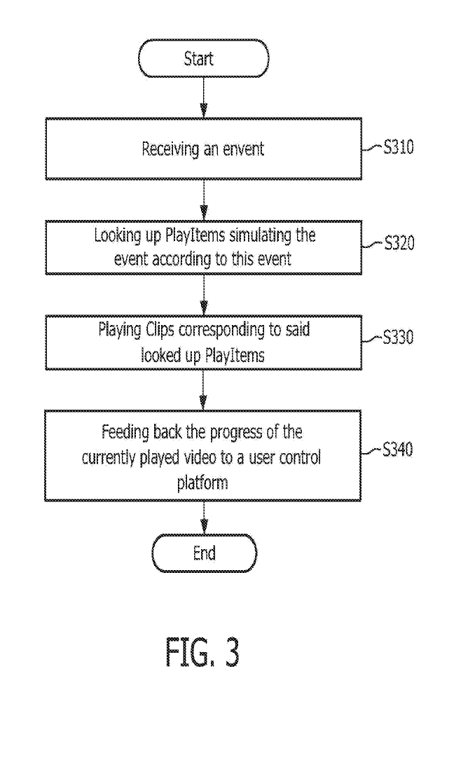

FIG. 3 is a basic flow chart of the video-playing method. The method comprises the steps of:

Receiving an event (S310). Said event comes from a user control platform that interactively controls playing of the content of an optical disc, for example, a game event.

Looking up the PlayItems that simulate said event according to the received events (S320). The PlayItems that simulate said events correspond to a play clip or a video stream file stored locally or in a network, or a segment of a play clip from 1 minute 30 seconds to 2 minutes 10 seconds. Such look-up may be carried out in various manners, for example, pre-setting a look-up table, wherein the author of the video stores the title of an event and the corresponding simulate PlayItems in the look-up table for rapid look-up while playing,

Playing the play clips to which the looked up PlayItems correspond (S330).

Optionally, when the video corresponding to the previous event has not been played completely, whereas a new event has been received, playing the video corresponding to the new event only after the playing of the previous segment of video has been completed, so as to guarantee continuity of the video.

Optionally, when the playing of the previous segment of video has been completed, whereas a new event has not been received, playing a segment of pre-defined video, for example, a close-up video relating to the previous segment of video or playing the previous segment of video in a cycle to wait for the next event, so as to guarantee continuity of the video.

Optionally, S340, feeding back the progress of the currently played video to a user control platform. The user control platform may adjust the progress of the video according to the residual events of the video playing, so that the process of the video is not too slow, this will avoid an impact on reality caused by discontinuous playing of the video when the video playing has been completed but the next event has not come yet.

This embodiment can be used to directly find the corresponding PlayItems according to the events issued from the user control platform, thereby avoiding restarting the PlayList and better realizing seamless playing of the video under the control of the user.

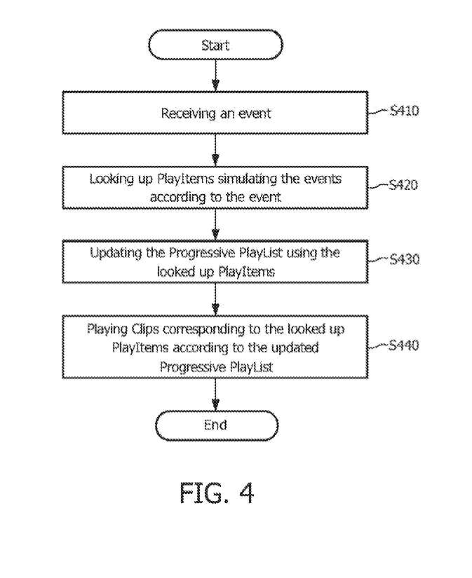

FIG. 4 is a flow chart according to another embodiment of the video-playing method of the invention.

There is a Progressive PlayList mechanism set in a BD (see Part 3-2 of the BD read-only format: Interactive Application Standard, Attachment AA, the standardizing portion of system description).

The Progressive PlayList is used to play a PlayList-like stream and download stream files from World Wide Web sites. The Progressive PlayList consists of a plurality of small PlayItems, and need not correspond to all Clip AV streams of the clips before playing is started. The play control engine can access one of the plurality of small PlayItems belonging to the Progressive PlayList and at the same time download another clip. The BD player may use a link preset in a Binding Unit to find the Progressive PlayList updated by the missing stream file.

In this embodiment, the Progressive PlayList presets the file titles of PlayItems in a fixed order, wherein the file titles of the PlayItems are simulated, rather than the file titles of the true PlayItems on the BD. The number of elements in the Progressive PlayList must be a sum of the amount of the pre-fabricated PlayItems and a certain number of virtual objects. The virtual objects can repeat scenario according to the design of the games. Some parameters in the Progressive PlayList, such as duration time, etc, can be open.

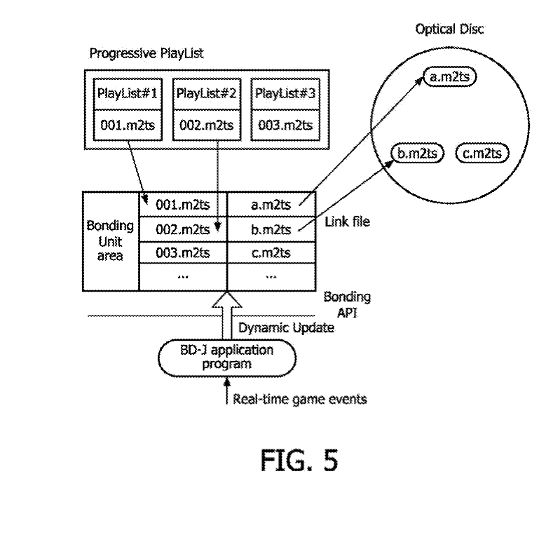

Please refer to FIG. 5 for the structural schematic diagram of the Progressive PlayList, wherein the Progressive PlayList only stores the file titles of some simulating PlayItems, for example, 001.m2ts, 002.m2ts, 003.m2ts . . . . However, the file titles of the PlayItems actually stored in BD may be a.m2 ts, b.m2 ts, c.m2 ts . . . . The link preset in the BD player bonding unit is linked to the file titles of the PlayItems actually played in BD.

The method comprises the steps of:

Receiving an event (S410), the event coming from a user control platform operated by a user, for example, a game event.

Looking up the PlayItems (S420) that simulate said event according to the received event.

Updating a Progressive PlayList (S430) using the looked up PlayItems. This procedure is to write the corresponding file links of the items actually played by BD into the Bonding Unit area, thereby forming in the Bonding Unit area a link between the file titles of the Progressive PlayList and the file titles of the items actually played in BD.

Playing the play clips corresponding to the PlayItems according to the Progressive PlayList (S440). The playback of the cutting linked to the Progressive PlayList can be realized by calling API in the org.bad.vfs package.

Since the playing units in the Progressive PlayList are directly PlayItems, using the manner of updating the Progressive PlayList to play video will be much easier to guarantee seamless playing of the video, which has particular advantages and acquires a stronger sense of reality.

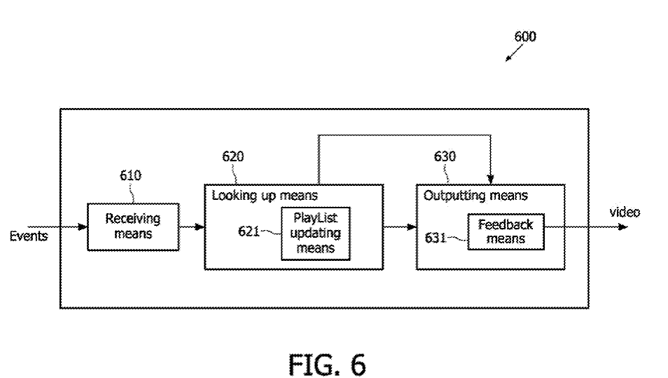

FIG. 6 is a structural block diagram according to an embodiment of the video-playing apparatus of the invention. The video-playing apparatus 600 of the invention is an optical disc player. The optical disc player may be a BD player, HD-DVD player, etc.

The video-playing apparatus 600 comprises a receiving means 610, a look-up means 620 and an output means 630.

The receiving means 610 is used to receive the events representing the user's choice sent from the user control platform. These events can be received via an interface of the video-playing apparatus. The interface may be various short-distance or long-distance communication interfaces, such as Blue-tooth, local area network, wireless local area network, infrared, etc.

The look-up means 620 is used to look up the play clips simulating the events according to these events. The correspondence relationship between the events and PlayItems is predefined by the author of video, and is stored in a look-up table, or the link files describing the correspondence relationship between the events and play clips, etc. The link files may be preset in a Bonding Unit of the playing apparatus 600 so as to link the Progressive PlayList on the optical disc with the actually played items. In this way, the look-up means 620 is enabled to look up, through the relationship between said predefined PlayItems and the look-up table (or link file), the PlayItems and dynamically form a new PlayList.

The output means 630 is used to play the play clips that correspond to the PlayItems.

The look-up means 620 may include a PlayList updating means 621. After the look-up means 620 has looked up the PlayItems that correspond to the events, the PlayList updating means 621 updates the PlayList. For example, the PlayList updating means 621 is used to update, in the Progressive PlayList, a link in the Bonding Unit between the file titles simulating the PlayItems and the file titles of the PlayItems actually played in BD, thereby updating the PlayList. After the PlayList has been updated, the playing means 630 plays the play clips corresponding to the events according to the PlayList.

The output means 630 may also include a playing state feedback means 631 for feeding back the playing state to the user control platform, so that the user control platform can adjust the progress of video and thereby guarantee the video playing to match with the user control.

In addition, when the previous segment of video has not been played completely, but a new event is received, the output means 630 outputs the video corresponding to the new event only after the previous segment of video has been output completely, thereby ensuring the continuity of video.

Besides, when the previous segment of video has already been played completely, but a new event has not been received, the output means 630 outputs a segment of predefined video, for example, a close-up video relevant to the previous segment of video to wait for the next event, so as to ensure the continuity of video.

It will be understood that said playing means and some or all of the units thereof may be realized by software.

The invention can also be realized by an appropriately programmed computer. The program configured in the computer can perform video playing, comprising: receiving an event from the user control platform; looking up the PlayItems that simulate the event according to this event; and playing the play clips corresponding to the PlayItems as looked up. Such computer program product may be stored on a storage carrier.

These program code portions can be provided on a processor to form a machine so that the codes executed on the processor generate the means accomplishing said function.

It will be understood that those skilled in the art are able to make various alterations, modifications and changes based on the contents described above. When such alterations, modifications and changes come within the scope of spirit and range of the appended claims of the invention, they will be considered to be within the scope of the invention. The above drawings and description thereof just explain instead of limit the invention. Any reference signs in the claims shall not be deemed to be limitations of the claims. The words “comprise” and “include” do not exclude the presence of other elements in addition to those recited in the claims. The words “a” and “an” preceding the elements do not exclude the presence of a plurality of such elements.

1. A video-playing method, wherein the video playing procedure is carried out according to the events issued from a user control platform, the method comprising the steps of:
a. receiving an event;
b. looking up the PlayItems that simulate the event according to this event; and
c. playing the play clips corresponding to said PlayItems.

2. The method according to claim 1, wherein step b further includes generating a new PlayList using the looked up PlayItems; and step c further includes outputting the play clips corresponding to said PlayItems according to the new PlayList.

3. The method according to claim 2, wherein said PlayList is a predefined Progressive PlayList and corresponds to a link of a Bonding Unit, the link of the Bonding Unit is also linked to the PlayItems, step b is to update the link between the Progressive PlayList and the PlayItems according to the looked up PlayItems; and step c is to play the play clips that correspond to the looked up PlayItems according to the Progressive PlayList that corresponds to the updated link.

4. The method according to claim 2, wherein step b is to look up the corresponding PlayItems in a predefined look-up table according to the event, and use the PlayItems to update the PlayList; and step c is to play the play clips that correspond to the looked up PlayItems according to said updated PlayList.

5. A video-playing apparatus, wherein the video playing procedure is carried out according to the events issued from a user control platform, the apparatus comprising:
a. receiving means for receiving an event;
b. looking-up means for looking up the PlayItems that simulate the event according to this event; and
c. output means for playing the play clips that correspond to said looked up PlayItems.

6. An apparatus according to claim 5, wherein said look-up means comprises an PlayList updating means for generating a new PlayList according to the looked up PlayItems; and an output means for outputting the play clips that correspond to the PlayItems according to the new PlayList.

7. The apparatus according to claim 6, wherein said PlayList is a predefined Progressive PlayList and corresponds to a link of a Bonding Unit, the link of the Bonding Unit is also linked to the PlayItems, the PlayList updating means is to update the link between the Progressive PlayList and the PlayItems according to the looked up PlayItems; and the output means is to output the play clips that correspond to the looked up PlayItems according to the Progressive PlayList that corresponds to the updated link.

8. The apparatus according to claim 6, wherein the lookup means is to look up the corresponding PlayItems in a predefined look-up table, and the PlayList updating means of the look-up means is to update the PlayList according to the PlayItems; and the output means is to output the play clips that correspond to the looked up PlayItems according to said updated PlayList.

9. A computer program product for playing video, wherein the video playing procedure is performed according to the events issued from the user control platform, the computer program product comprising:
a code for receiving an event;
a code for looking up the PlayItems that simulate the events according to this event; and
a code for playing the play clips that correspond to the looked up PlayItems.

10. A storage carrier including the computer program product as recited in claim 9.
